(19) United States
(12) Patent Application Publication
(10) Pub. No.: US 2014/0258235 A1
(43) Pub. Date: Sep. 11, 2014

(54) METHOD TO PROVIDE USER DOMAIN MANAGEMENT OF SNAPSHOTS FOR VIRTUAL DESKTOPS USING CENTRALIZED PORTAL

(71) Applicant: VCE COMPANY LLC, Richardson, TX (US)

(72) Inventors: Zunhe JIN, Sunnyvale, CA (US); Akshaya K. MAHAPATRA, San Jose, CA (US); Michael TAN, Palo Alto, CA (US); Wei TIAN, Fremont, CA (US); Lily CUI, Saratoga, CA (US)

(73) Assignee: VCE COMPANY LLC, Richardson, TX (US)

(21) Appl. No.: 13/786,047

(22) Filed: Mar. 5, 2013

(51) Int. Cl. G06F 17/30

(52) U.S. Cl. CPC G06F 17/30088
USPC 707/639

(57) ABSTRACT

A snapshot agent executing on a virtual desktop allows a user to both create snapshots of the VM image hosting the virtual desktop and to revert that VM instance to such snapshots. In addition to a snapshot agent that executes within a given VM instance, another embodiment provides a user with network access to a portal snapshot management interface, e.g., via a web application. The web application can present the list of VM instances, and snapshots for each such VM instance, owned by an authenticated user. The user can then interact with the web application to create a new snapshot for (or revert to) an existing snapshot for the owned VM instances.

### BACKGROUND OF THE INVENTION

1. Field of the Invention

Embodiments of the present invention generally relate to managing computing resources. More specifically, embodiments of the invention provide users with the ability to create, revert, and manage snapshots of running virtual machine instances.

2. Description of the Related Art

In a virtualized computing environment, virtual machine instances (VMs) are configured to run on a collection of physical hosts. Each virtual machine instance uses compute resources (e.g., CPU and memory), network resources (e.g., network interfaces), and storage resources (e.g., local disks, NAS or SAN connections) of the underlying physical host system. An administrator of the virtualized environment can configure the virtualized compute resources provisioned for each virtual machines on the host system. A hypervisor (also referred to as a virtual machine monitor) then provides the virtualized computing resources to the VM instances from the physical resources of the host. Once provisioned and running, each virtual machine operates as a separate, stand-alone computing system. And each VM instance executes over the virtualized computing resources, i.e., each VM instance runs its own operating system and application programs on the virtual resources managed by the hypervisor.

One use of a virtualized computing environment is to provide users with access to virtual desktops. In such a case, a user's desktop environment is typically provided by a virtual machine running on a host in a data center. Users access their desktop using a remote desktop protocol (e.g., RDP or VNC) and remote client software. Doing so presents the user with an interface to a guest operating system as though they were interacting with that virtual machine instance directly.

The virtualized computing environment may use a management server to control users accessing their virtual desktop and VM instances. Such a management server allows users to log in and connect users to their desktop sessions. For example, the management server may connect a user to (or create) a VM instance when a user logs in, suspend the VM instance as needed, move the VM instance based on user location, and provided a variety of other management services.

In addition, the management server can be used to create a snapshot of a VM. A snapshot captures a execution state of the VM instance that can be restored at a later time. However, individual users interacting with a virtual desktop cannot create snapshots of their virtual desktops by themselves. This occurs, in part, due to the virtualization itself. As the guest operating system and virtual desktop runs on the underlying virtualized hardware transparently, there is no mechanism within the guest operating system to access the management server. As a result, if a user needs to create a snapshot of a virtual desktop, or revert to a prior snapshot, they have to go through a system administrator which is both inconvenient and time consuming. In other cases, where a user is executing multiple VM instances (and not just accessing a virtual desktop), a user may need to perform batch operations, creating (or reverting to) a snapshot for multiple VM instances.

### SUMMARY OF THE INVENTION

Embodiments presented herein include a method for managing computing resources. This method may generally include receiving, over a network, a request to access a snapshot portal management interface, authenticating a set of credentials identifying a user associated with the request, and identifying one or more virtual machine instances associated with the authenticated user. This method may further include presenting the identified virtual machine instances on the snapshot portal management interface, receiving, over the snapshot portal management interface, a request to perform a snapshot operation on at least a first one of the virtual machine instances, and performing the requested snapshot operation on at least the first virtual machine instance.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an example computing infrastructure configured to allow users to create and manage VM snapshots, according to one embodiment.

FIG. 2 illustrates a reference example of a user-domain snapshot request submitted to virtual desktop infrastructure, according to one embodiment.

FIG. 3 illustrates an example of a virtual machine instance configured with a user-domain snapshot agent, according to one embodiment.

FIG. 4 illustrates an example of a snapshot hierarchy, according to one embodiment.

FIG. 5 illustrates a method for a user-domain snapshot agent to create a snapshot of a virtual machine instance, according to one embodiment

FIG. 6 illustrates a method for a user-domain snapshot agent to revert to a snapshot of a virtual machine instance, according to one embodiment.

FIG. 7 illustrates a method for managing virtual machine snapshots, according to one embodiment.

To facilitate understanding, identical reference numerals are occasionally used to designate common figure elements. It is contemplated that elements disclosed in one embodiment may be beneficially used in other embodiments without specific recitation.

### DETAILED DESCRIPTION

Embodiments of the invention provide techniques that allow users to create and manage snapshots for virtual machine (VM) instances from a user-level domain. That is, the disclosed techniques allow users to create (and revert to) snapshots without requiring administrator intervention. Doing so empowers users to self-service their own snapshots while also saving system administrators' time. Further, the approaches described herein maintain a secure environment, where users are limited to creating, reverting, or otherwise accessing VM snapshots only for VM instances they own within a computing domain. For example, a user can create (or revert) a snapshot corresponding to the VM instance providing their virtual desktop, but does not allow the user to do the same for other VM instances. To provide this security, a snapshot portal may be configured to authenticate any user-domain request to create (or revert) a VM instance snapshot.

In one embodiment, a guest operating system is configured with a user agent that can request to create (or revert) a snapshot of the VM instance hosting the guest operating system. That is, the user agent allows a user to “step outside” of the otherwise transparent virtualization and request snapshot operations for the VM instance running the guest operating system. To do so, the user agent connects to a backend snapshot portal server using login credentials of the current user. The portal server authenticates the credentials, e.g., by interacting with a LDAP server or Active Directory server. Provided the credentials are validated, the portal server then connects to virtualization management server to identify a snapshot tree (if any) for the VM instance providing the user's virtual desktop. The snapshot tree is passed back to the user agent, which displays the tree to the user. If the user requests to create a new snapshot or revert to an existing snapshot for that VM instance, the agent sends the request to the portal server, which forwards the request to the virtualization management server to carry out the requested snapshot operation. Because the requests are authenticated, a user can only request to create (or revert) a snapshot if they own the corresponding virtual machine instance hosting the guest operating system and user agent. Thus, if multiple users can access a given VM instance, e.g., using different user accounts to access a remote desktop on the VM instance, only the user that actually owns the VM instance can view, create, and manage snapshots for that VM instance.

In addition to a user agent that executes within a given VM instance, another embodiment provides a user with network access to the snapshot portal server. For example, in one embodiment, the snapshot portal server may be accessed using a web application. In such a case, the portal server can validate a request to manage snapshots by linking to an authentication server (e.g., Active Directory/LDAP). Any user who owns a VM instance can use a web browser to log into the web application with the same credentials used with their virtual desktops. Once a user logs in, the portal server can return a list of virtual machine instances (e.g., virtual desktops) owned by that user. The web application can present the list of VM instances and a snapshot tree for each such VM instance (if any snapshots have been cut). The user can then interact with the web application to create a new snapshot for (or revert to) an existing snapshot for the owned VM instances. Note, this approach also allows a user to create (and revert) snapshots for VM instances using batch operations. For example, assume a user owns multiple VM instances, in such a case, the web-application may allow the user to create (or revert) snapshots for groups of VM instances essentially simultaneously.

Further, in addition to allowing users to create and manage VM instance snapshots, the user agent, web application, and portal server may be configured to allow users to perform a variety of operations for VM instances that “break” the virtualization transparency or require administrator intervention. For example, the user agent could allow a user to add (or request) more resources for a running VM instance (e.g., to request more processing power for the virtualized CPU associated with a user's virtual desktop), check for any errors/alerts related to their virtual desktop (which are visible from the virtualization management sever), rename a virtual machine or guest host name, or request to migrate their VM instance to a different host/cluster (e.g., to improve performance or latency).

In the following, reference is made to embodiments of the invention. However, the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet. In context of the present invention, a cloud based application may be configured to allow a user to create and manage snapshots created for VM instances hosted in the cloud based environment.

As noted, embodiments are described herein using the snapshot operation as a reference example of a user level operation performed via a user agent and snapshot portal server. However, one of ordinary skill in the art will recognize that embodiments of the invention may be adapted to allow users to perform a variety of other commands used to manage VM instances owned by that user that would otherwise require administrator intervention or require visibility “outside” of the VM instance and guest operating system.

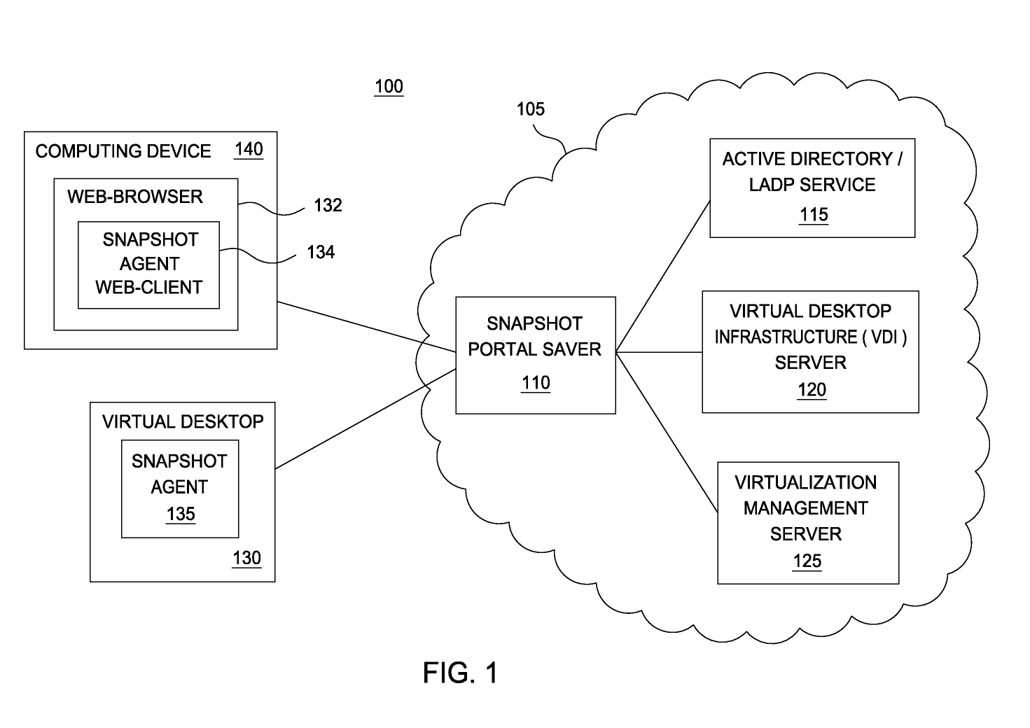

FIG. 1 illustrates an example computing infrastructure 100 configured to allow users to create and manage VM snapshots, according to one embodiment. As shown, a cloud-based infrastructure 105 hosts a snapshot portal server 110, an active directly/LDAP service 115, a virtual desktop infrastructure (VDI) 120, and a virtualization management server 125. Illustratively, a virtual desktop 130 and web-browser 132 access the snapshot portal server 110 to request snapshot operations for VM instances hosted by the VDI 120.

Virtual desktop 130 provides a computing environment that users can access remotely from any location using a remote desktop application. The virtual desktop 130 presents a user with a graphical user interface of a remote computer system that may be controlled, e.g., using a mouse, keyboard, touch screen, etc., of the computing device executing the remote desktop software. Thus, a remote desktop may be accessed using a PC or laptop computer, as well as using other computing device with remote desktop applications, including, e.g., computing tablet and mobile telephones.

Typically virtual desktop 130 accesses a guest operating system executing in a virtual machine instance (container) on the VDI 120. The VDI 120 provides a collection of physical computing systems that can host VM instances. In turn, the virtualization management server 125 provides a computing system configured to manage the VM instances on the VDI 120. For example, the management server 125 may be configured to launch a VM instance and guest operating system on VDI 120 to provide a user with a virtual desktop. Similarly, management server 125 may be used to suspend or restore operation of such a VM instance when the user logs in/out of the virtual desktop. The management server can also configure the resources allocated to a given VM instance (e.g., compute, network, and storage resources) as well as move a VM instance from one physical host to another.

In addition, the management server 125 can create a snapshot of a VM instance. A snapshot generally refers to a complete running state of a VM instance, including, e.g., storage, memory, register, interrupt, and stack state for the virtualized compute resources associated with the VM instance. By restoring the running state of a snapshot, the VM may be reverted to a state of operation mirroring that of when the snapshot was captured. Because the snapshot captures the state of the VM instance container itself, it cannot be performed “internally” by the guest operating system running on the virtualized computing resources of the VM instance.

In one embodiment, the snapshot portal server 110 may interact with the virtualization management server 125 to creature user-directed snapshots of VM instance hosted by the VDI 120. For example, a snapshot agent 135 may be a user-level software application executed on a virtual desktop 130. The snapshot agent 135 may connect to the snapshot portal server 110 to request a snapshot of the VM instance on the VDI 120 hosting a guest operating system and virtual desktop 130. In response to such a request, the snapshot portal server 110 may be configured to identify both the VM instance associated with the virtual desktop 135 (e.g., by an IP address or other identifier) and the user that owns the VM instance. For example, the user may supply authentication credentials (e.g., a username and password, etc.) That the snapshot portal server can validate using the Active Directory/LDAP service 115. Presuming a user provides the appropriate credentials, the portal server can provide the snapshot agent 135 with a list of available snapshots for the VM instance hosting the virtual desktop 135. In turn, the user interacting with the virtual desktop 135 can create a new snapshot of the VM instance hosting the virtual desktop 135 or revert to a prior state by restoring a snapshot created for the same VM instance.

In one embodiment, users can also manage snapshots created for a VM instance hosted by VDI 120 via the snapshot agent web-client 134. As shown, the web-client 134 is presented in web browser 132 on computing device 140. The computing device 140 executing the web browser 132 may be a PC or laptop computer, as well as other computing devices, including, e.g., computing tablet and mobile telephones configured with a web browser application. Regardless of the particular computing device 140, the snapshot agent web-client 134 may prompt for a set of user credentials supplied to the snapshot portal server 110. In turn, the snapshot portal server 110 authenticates a user request (e.g., via the active directory/LDAP service 115) and identifies both VM instances owned by the authenticated user, and snapshot trees created for such VM instances. The snapshot agent client 134 may also allow the user to revert to any snapshot instance cut for one of their VM instances and to create snapshots for their VM instances.

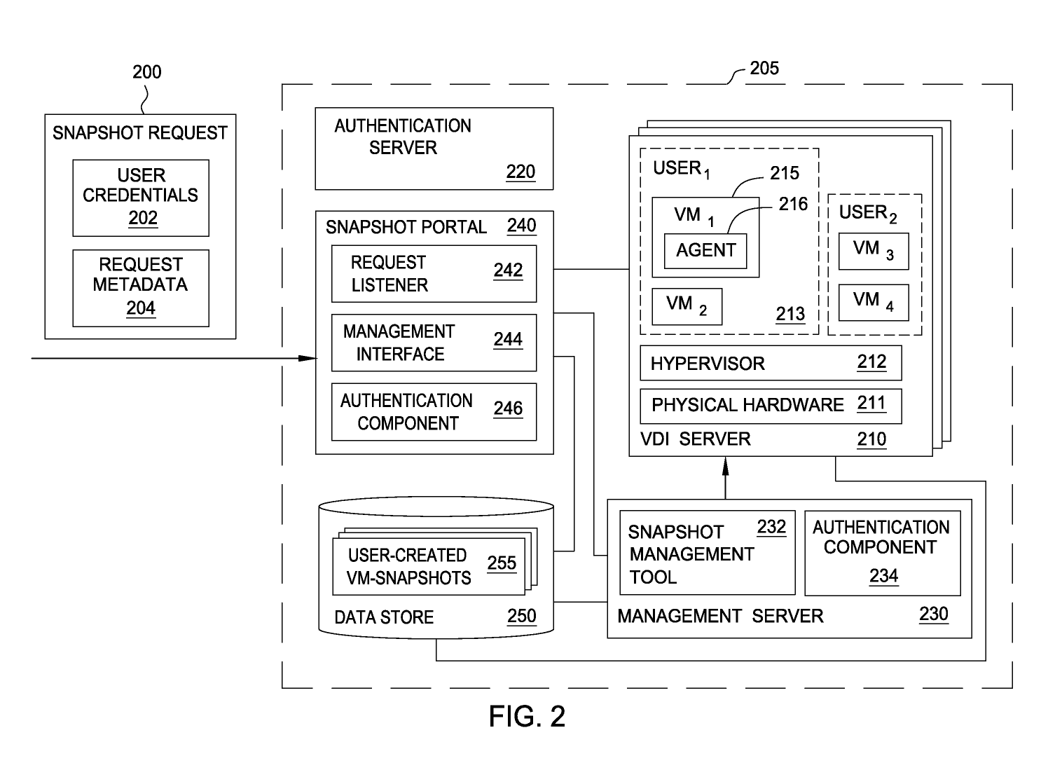

FIG. 2 illustrates a reference example of a user-domain snapshot request 200 submitted to a computing infrastructure 205, according to one embodiment. As shown, the computing infrastructure 205 includes a collection of VDI servers 210, an authentication server 220, a virtualization management server 230, a snapshot portal server 240, and a data store 250. The VDI server 210 includes a hypervisor used to manage the execution of multiple virtual machine instances. The VDI server 210 includes physical computing resources, e.g., a CPU, memory, networking interfaces, storage resources (or connections, etc.). For example, a VDI server 210 may be a server blade in a converged infrastructure or a rack mounted server system in a data center.

In this example, the VDI server 210 is executing four VM instances (labeled VM₁₋₄). Two VM instance—VM₁ and VM₂ are owned by a first user (User)) and two VM instance VM₃ and VM₄ are owned by a second user (User₂). Additionally, VM ₁ 215 includes a user agent 216 used to create and manage snapshots 255 of this VM instance.

The virtualization manger server 230 provides one or more software applications used to create and manage VM instances on the VDI servers 210. For example, the snapshot management tool 232 may be configured to create snapshots of VM instances, store the snapshots 2545 in data store 250, and revert (i.e., restore) the snapshot of a given VM instance. Additionally, the management server 232 may configure or provision a VM instance, e.g., by allocating (or re-allocating) the physical hardware 211 of a VDI server 210 to a given VM instance. The management server 232 may also launch a VM instance used to provide a user with a virtual desktop. For example, when a user authenticates their identify and requests a virtual desktop, if no VM instance had been launched for that user, then the management server 232 may launch a new VM instance, boot an operating system within that instance, and provide the user with a virtual desktop connection to access the virtualized computing system.

The authentication component 234 allows the management server to interact with the authentication server 220 (e.g., an Active Directory service/LDAP server) to validate a given user logon or other user request). The data store 250 provides storage resources for the VDI server 210 (e.g., as a SAN or other storage fabric) as well as provide storage resources for user-created VM snapshots 255. The VM snapshots 255 correspond to snapshots created by users from within their VM instances (e.g., from user agent 216 executed by VM₁ 215).

The snapshot portal 240 provides one or more software applications executing within the computing infrastructure 205 configured to allow users to create and manage snapshots from within a virtual desktop directly or from a web-based client. As shown, the snapshot portal 240 includes a request listener 242 and management interface 244 and an authentication component 246. The request listener 242 provides software components configured to receive a request 200 from a user agent running in a virtual desktop (e.g., agent 216 on running on VM instance 215) or for web-based access manage VM instance snapshots. The authentication component 246 may be configured to communicate with the authentication server 220 to authenticate a given user request.

The management interface 244 allows the snapshot portal sever 240 to interact with the management server 230 and snapshot management tool 232. The snapshot portal server 240 receives a snapshot request 200 from a user (e.g., agent 216 on running on VM instance 215). Illustratively, the request 200 includes user credentials 202 and request metadata 204. Once received, the authentication component 246 verifies the authenticity of the request 200, e.g., by communicating with the authentication server 220. Once verified the snapshot portal may identify a VM instance associated with the authenticated using the request metadata 204. For example, the request metadata 204 may identify the IP address of the VM instance owned by the authenticated user or provide other information used to identify VM instances owned by a given user. Once identified, the snapshot portal may receive a request to create (or revert) a snapshot of a VM instance owned by the authenticated user. For example, the snapshot portal will allow User₁ to create (and revert) snapshots 255 created for VM₁ and VM₂, but not allow User1 to create (or revert) snapshots created for VMs owned by User₂ (i.e., for VM₃ or VM₄). The management interface 244 of the snapshot portal sever 240 may communicate with snapshot management tool 232 to create (or revert) a snapshot (or snapshots) as requested by the user agent or web-client.

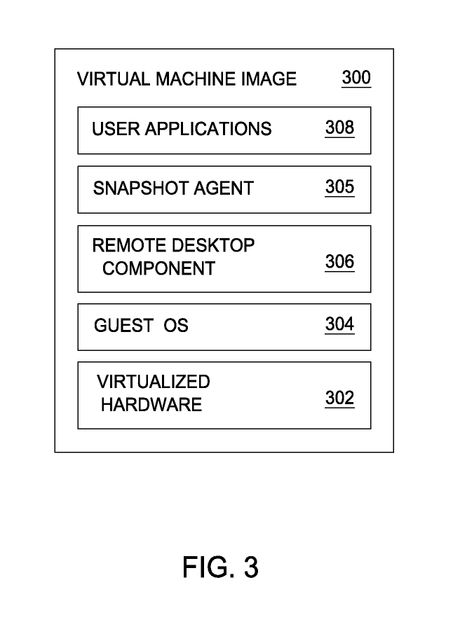

FIG. 3 illustrates an example of a virtual machine (VM) instance 300 configured with a user-domain snapshot agent, according to one embodiment. As shown, the VM instance 300 includes virtual hardware resources 302, a guest operating system 304, a snapshot agent 305, a remote desktop component 306, and user applications 308. The virtual hardware resources 302, e.g., a virtual CPU, memory, network, and storage, provide a virtual computing system for guest operating system 304. Together the virtual hardware resources 302 and guest OS 304 provide a virtualized computing platform for user applications 308. For example, a user may access virtualized computing platform using a remote desktop client and remote desktop component 306. Further, the snapshot agent 305 allows a user accessing a virtual desktop to create snapshots of the virtual machine instance 300 hosting that virtual desktop as well as revert to stored snapshots of the virtual machine instance 300.

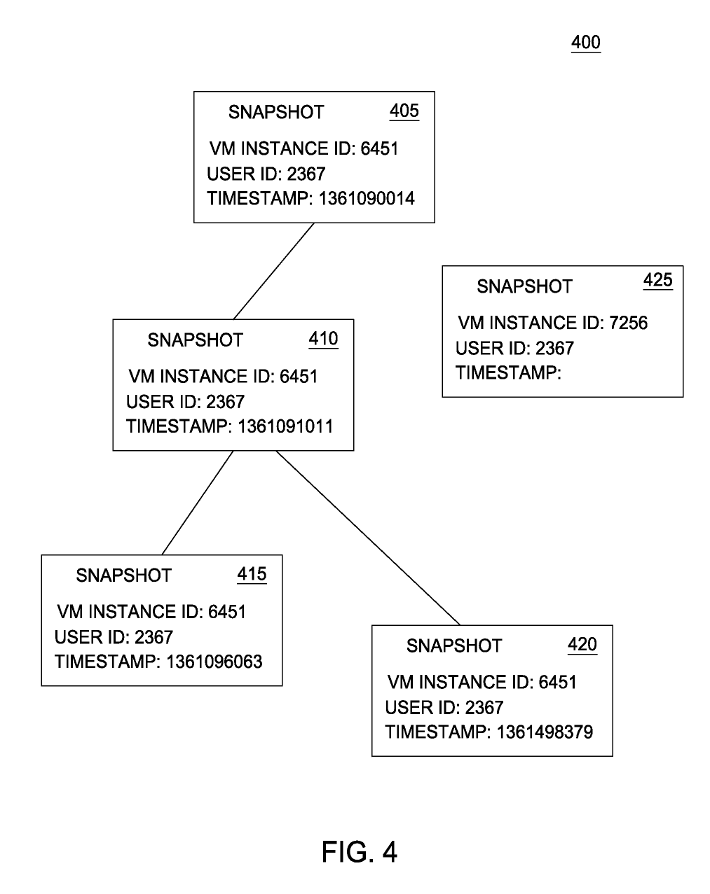

FIG. 4 illustrates an example of a snapshot hierarchy 400, according to one embodiment. In this example, a user has created a snapshot tree for one VM instance and a single snapshot for another VM instance. Each snapshot identifies an associated VM instance ID, a user ID for a user that owns the VM instance, and a timestamp indicating when the snapshot was cut for a given VM instance. In this example, snapshot images 405, 410, 415, and 420 provide a snapshot tree for one VM instance. Each snapshot corresponds to a running state of this VM instance captured at a particular point in time. Starting from the earliest time, snapshot 405 has a single descendant snapshot 410. However, snapshot 410 has two descendants, snapshot 415 and snapshot 420. The branching from one snapshot to multiple descendants may occur by reverting to a given snapshot multiple times. For example, after creating snapshot 410 and later creating snapshot 415, the user could revert to snapshot 410. After the reversion, creating snapshot 420 results in a second branch back to snapshot 410.

Independent from snapshot tree (snapshots 405, 410, 415, and 420), the same user has created a single snapshot 425 for another VM instance. Any snapshots subsequently created for this VM instance will descend from snapshot 425.

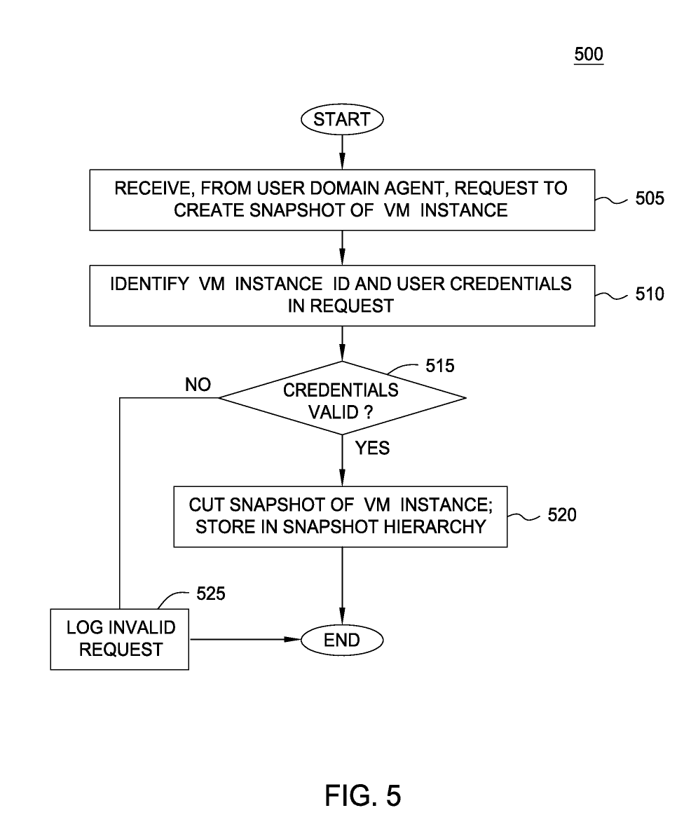

FIG. 5 illustrates a method 500 for a user-domain snapshot agent to create a snapshot of a virtual machine instance, according to one embodiment. As shown, the method 500 begins at step 505, where the snapshot portal agent receives a user agent request to create a snapshot of an associated VM instance. For example, a user may execute a snapshot user agent from within a virtual desktop. As described, such a user agent may connect to the snapshot portal server to request a snapshot be created for the VM instance hosting the virtual desktop. In response to the request, at step 510, the snapshot portal server identifies a VM instance associated with the user agent making the request. That is, the portal server identifies the VM instance hosting the user's virtual desktop. At step 510, the portal sever also identifies (or prompts for) user credentials needed to authenticate the request. At step 515, the portal server determines whether the credentials supplied at step 510 are valid. For example, the portal server may supply the credentials to an authentication service, e.g., an active directory or LDAP service. Assuming the credentials are validated successfully, the portal server creates the requested snapshot and stores the snapshot in a data store (step 520). For example, the portal server may interact with a virtualization management server overseeing a VDI or other cluster of computing systems hosting VM instances to request a snapshot of a running VM instance. Otherwise, if the credentials cannot be validated, the portal server may log the invalid request (step 525). The portal server may also take a variety of actions, including, e.g., notifying the owner (or system administrator) of a VM instance that an unauthorized snapshot attempt occurred.

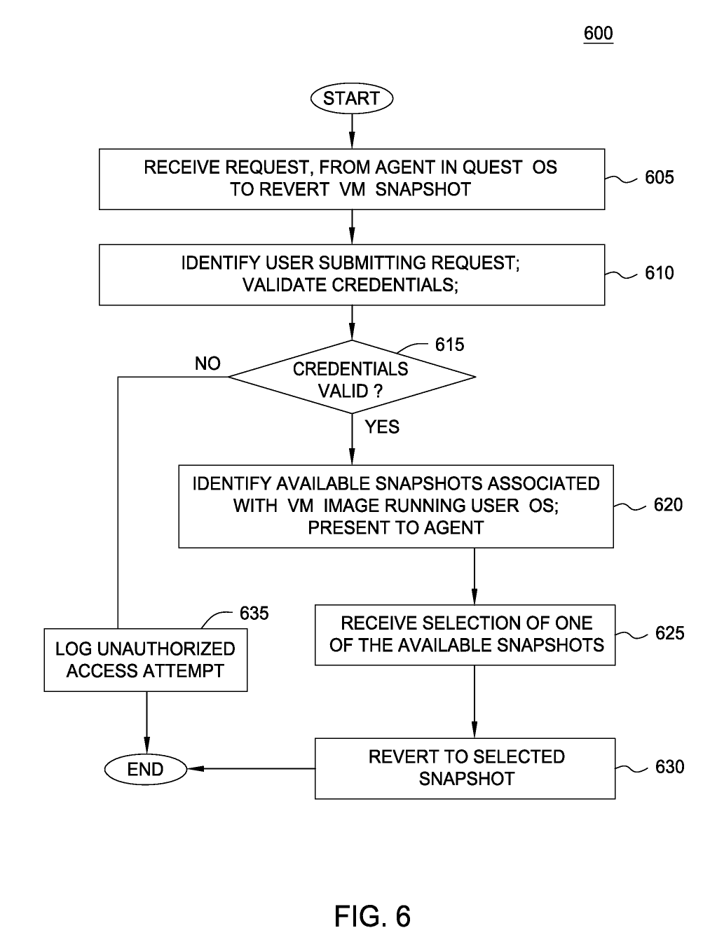

In addition to creating snapshots, the user agent running on a virtual desktop also allows a user to revert the corresponding VM instance to the state captured in a prior snapshot. For example, FIG. 6 illustrates a method 600 for a user-domain snapshot agent to revert to a snapshot of a VM instance, according to one embodiment. As shown, the method 600 begins at step 605, where the snapshot portal agent receives a user agent request to revert a VM instance to a snapshot state. As described, a user agent may connect to the snapshot portal server to request to revert the VM instance hosting the virtual desktop to a snapshot. In response to the request, at step 610, the snapshot portal server identifies a VM instance associated with the user agent making the request. That is, the portal server identifies the VM instance hosting the user's virtual desktop. At step 610, the portal sever also identifies (or prompts for) user credentials needed to authenticate the request. At step 615, the portal server determines whether the credentials supplied at step 610 are valid. For example, the portal server may supply the credentials to an authentication service, e.g., an Active Directory or LDAP service.

If the portal server validates the credentials successfully, then the VM instance hosting the user agent may be reverted to a stored snapshot. Accordingly, at step 620, the portal server may identify what snapshots matching the VM instance running the user agent are available in a data store, e.g., by interacting with a virtualization management system. Once identified, the portal server may pass the list of available snapshots back to the user agent running in the user's virtual desktop. At step 625, the portal server receives a selection of one of the available snapshots. And at step 630, the portal server reverts the VM instance to the snapshot selected at step 625. Doing so disconnects the user from the running instance. Accordingly, the user owning the VM instance (and any other users running a remote desktop session in that VM instance) may be notified that the system is going down and that each user will be logged off. Otherwise, if the credentials cannot be validated, the portal server may log the invalid request (step 635). The portal server may also take a variety of actions, including, e.g., notifying the owner (or system administrator) of a VM instance that an unauthorized attempt to revert a VM instance occurred.

Note, method 600 and method 700 are described as creating (and reverting) snapshots for the VM instance hosting a guest operating system and user agent tool used to create and revert snapshots of that VM instance. However, one of ordinary skill in the art will recognize that the user agent tool running within one virtual desktop may be used to create and revert snapshots for other virtual machine instances. For example, the snapshot portal server could retrieve a list of all running VM instances (and snapshots) associated with a given user. That is, the portal server could identify all the VM instances owned by a given user and allow the user to create snapshots of such VM instances and revert such VM instances to other snapshots. In such a case, the portal server again uses the same validated user credentials to identify what VM instances (and snapshots) a given user is authorized to manage. Further, the portal server may be configured to allow the user to perform a variety of other commands or actions that would otherwise require administrator intervention. For example, the user agent could allow a user to add (or request) more resources for a running VM instance (e.g., to request more processing power for the virtualized CPU associated with a user's virtual desktop), check for any errors/alerts related to their virtual desktop (which are visible from the virtualization management sever), rename a virtual machine or guest host name, or request to migrate their VM instance to a different host/cluster (e.g., to improve performance or latency).

In one embodiment, the portal server exposes a web-based interface configured to allow a user to create and manage snapshots for their VM instances. Doing so allows a user to manage snapshots of owned VM instances without having to be logged into a virtual machine instance or accessing a virtual desktop. Instead, the web-based interface to the portal server allows a user to manage their VM instances and snapshots from any web-connected device.

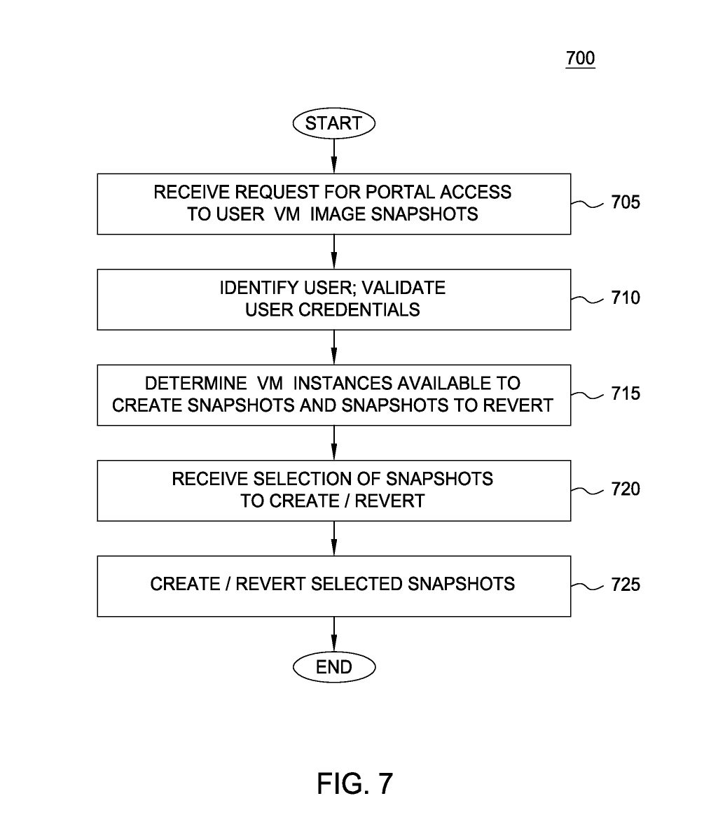

For example, FIG. 7 illustrates a method 700 for managing virtual machine snapshots, according to one embodiment. As shown, the method 700 begins at step 705 where the snapshot portal server receives a request to access a user VM instance and snapshot management interface. For example, in one embodiment, the snapshot portal server may be configured to host and serve a web application which allows a user to manage their VM instances and snapshots. At step 710, the snapshot portal server identifies a user associated with the request. For example, web-based portal may require a user to supply a username and password (or other authentication credential) to access the VM instance and snapshot management interface. Once received, the portal server authenticates the credentials, e.g., by interacting with an active directory/LDAP service. At step 715, the portal server identifies a set of running VM instances (e.g., a set of virtual desktops) owned by the user identified at step 710. Additionally the portal server identifies any snapshots available for the running VM instances. The set of running VM instances and snapshots is presented to the user over the VM instance and snapshot management interface. At step 720, the portal server receives a selection of one or more snapshots to create for corresponding VM instances or receives a selection of one or more snapshots to revert to for corresponding VM instances. That is, the user may interact with the management interface to create new snapshots or revert to VM images to existing snapshots as desired both individually and in batch operations.

Advantageously, as described above, embodiments of the invention provide a mechanism to manage VM instances. In one embodiment, a snapshot agent executing on a virtual desktop allows a user to both create snapshots of the VM image hosting the virtual desktop and to revert that VM instance to such snapshots. In addition to a snapshot agent that executes within a given VM instance, another embodiment provides a user with network access to a portal snapshot management interface, e.g., via a web application. The web application can present the list of VM instances, and snapshots for each such VM instance, owned by an authenticated user. The user can then interact with the web application to create a new snapshot for (or revert to) an existing snapshot for the owned VM instances.

Various embodiments of the present disclosure may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments and numerous specific details are set forth to provide a more thorough understanding of the invention. Persons skilled in the art, however, will understand that various modifications and changes may be made thereto without departing from the broader spirit and scope of the invention. The foregoing description and drawings are, accordingly, to be regarded in an illustrative rather than a restrictive sense.

While the foregoing is directed to embodiments of the present disclosure, other and further embodiments of the present disclosure may be devised without departing from the basic scope thereof, and the scope thereof is determined by the claims that follow.

What is claimed is:

1. A method for managing computing resources, comprising:
receiving, over a network, a request to access a snapshot portal management interface;
authenticating a set of credentials identifying a user associated with the request;
identifying one or more virtual machine instances associated with the authenticated user;
presenting the identified virtual machine instances on the snapshot portal management interface;
receiving, over the snapshot portal management interface, a request to perform a snapshot operation on at least a first one of the virtual machine instances; and
performing the requested snapshot operation on at least the first virtual machine instance.

2. The method of claim 1, wherein the snapshot operation is to capture a snapshot of at least the first virtual machine instance.

3. The method of claim 1, wherein the snapshot operation is to revert at least the first virtual machine instance to a state in a previously captured snapshot of the first virtual machine instance.

4. The method of claim 3, wherein the previously captured snapshot is one of a plurality of snapshots of the first virtual machine instance.

5. The method of claim 1, further comprising:
for one or more of the identified virtual machine instances, identifying one or more snapshots, wherein each snapshot is associated with a corresponding one of the identified virtual machine instances; and presenting the identified snapshots on the snapshot portal management interface.

6. The method of claim 5, wherein the first virtual machine instance is accessed as a virtual desktop using a remote desktop application.

7. The method of claim 1, wherein the snapshot operation requests a batch operation (i) to capture a snapshot for a plurality of the identified virtual machine instances or (ii) to revert each of a plurality of the identified virtual machine instances to a sate captured in a respective snapshot.

8. A computer-readable storage medium comprising instructions which, when executed in a computing device, perform an operation for managing computing resources, the operation comprising:
receiving, over a network, a request to access a snapshot portal management interface;
authenticating a set of credentials identifying a user associated with the request;
identifying one or more virtual machine instances associated with the authenticated user;
presenting the identified virtual machine instances on the snapshot portal management interface;
receiving, over the snapshot portal management interface, a request to perform a snapshot operation on at least a first one of the virtual machine instances; and
performing the requested snapshot operation on at least the first virtual machine instance.

9. The computer-readable storage medium of claim 8, wherein the snapshot operation is to capture a snapshot of at least the first virtual machine instance.

10. The computer-readable storage medium of claim 8, wherein the snapshot operation is to revert at least the first virtual machine instance to a state in a previously captured snapshot of the first virtual machine instance.

11. The computer-readable storage medium of claim 10, wherein the previously captured snapshot is one of a plurality of snapshots of the first virtual machine instance.

12. The computer-readable storage medium of claim 8, wherein the operation further comprises:
for one or more of the identified virtual machine instances, identifying one or more snapshots, wherein each snapshot is associated with a corresponding one of the identified virtual machine instances; and
presenting the identified snapshots on the snapshot portal management interface.

13. The computer-readable storage medium of claim 8, wherein the first virtual machine instance is accessed as a virtual desktop using a remote desktop application.

14. The computer-readable storage medium of claim 8, wherein the snapshot operation requests a batch operation (i) to capture a snapshot for a plurality of the identified virtual machine instances or (ii) to revert each of a plurality of the identified virtual machine instances to a sate captured in a respective snapshot.

15. A computing system, comprising:
a processor; and
a memory storing one or more application programs, which when executed on the processor perform an operation for managing computing resources, the operation comprising:
receiving, over a network, a request to access a snapshot portal management interface,
authenticating a set of credentials identifying a user associated with the request,
identifying one or more virtual machine instances associated with the authenticated user,
presenting the identified virtual machine instances on the snapshot portal management interface,
receiving, over the snapshot portal management interface, a request to perform a snapshot operation on at least a first one of the virtual machine instances, and
performing the requested snapshot operation on at least the first virtual machine instance.

16. The system of claim 15, wherein the snapshot operation is to capture a snapshot of at least the first virtual machine instance.

17. The system of claim 15, wherein the snapshot operation is to revert at least the first virtual machine instance to a state in a previously captured snapshot of the first virtual machine instance.

18. The system of claim 17, wherein the previously captured snapshot is one of a plurality of snapshots of the first virtual machine instance.

19. The system of claim 15, wherein the operation further comprises:
for one or more of the identified virtual machine instances, identifying one or more snapshots, wherein each snapshot is associated with a corresponding one of the identified virtual machine instances; and
presenting the identified snapshots on the snapshot portal management interface.

20. The system of claim 15, wherein the first virtual machine instance is accessed as a virtual desktop using a remote desktop application.

21. The system of claim 15, wherein the snapshot operation requests a batch operation (i) to capture a snapshot for a plurality of the identified virtual machine instances or (ii) to revert each of a plurality of the identified virtual machine instances to a sate captured in a respective snapshot.
